(19) United States
(12) Patent Application Publication
(10) Pub. No.: US 2012/0217242 A1
(43) Pub. Date: Aug. 30, 2012

(54) VENTED TRASH RECEPTACLE

(76) Inventors: Joseph L. Dyer, Fort Meyers, FL (US); Michael K. Lane, Newton, KS (US)

(21) Appl. No.: 13/396,445

(22) Filed: Feb. 14, 2012

Related U.S. Application Data
(60) Provisional application No. 61/446,847, filed on Feb. 25, 2011.

(51) Int. Cl. B65F 1/12; B65F 1/16

(52) U.S. Cl. 220/200; 220/661

(57) ABSTRACT

The vented trash receptacle has walls encompassing an inner space. The receptacle has a closed bottom and an open top. A removable lid is provided to close the open top. Handles are disposed on the outer surface of the receptacle. Hollow vent tubes are attached to the outer surface of the receptacle. Each tube has a lower end that opens into the inner space of the receptacle adjacent the closed bottom. The upper end of each tube opens into a respective chamber formed beneath a respective handle and open to ambient air, thereby preventing foreign objects and substances from clogging the tube passageways.

### CROSS-REFERENCE TO RELATED APPLICATION

This application claims the benefit of U.S. Provisional Patent Application Ser. No. 61/446,847, filed Feb. 25, 2011.

### BACKGROUND OF THE INVENTION

1. Field of the Invention

The present invention generally relates to receptacles, and particularly to a vented trash receptacle having air ducts to mitigate suction created by removal of a flexible trash can liner.

2. Description of the Related Art

When inserting a conventional, flexible, collapsible liner into a typical trash receptacle, a problem occurs when air trapped between the flexible liner and the interior walls of the receptacle prevents the liner from readily assuming a configuration coextensive with the inner walls of the receptacle. An additional problem occurs when removing the trash-laden liner from the receptacle in that a partial vacuum occurs in the space immediately below the liner and the bottom wall of the receptacle during the attempted removal. The vacuum created by removing a full trash bag makes it more difficult to remove the trash-laden liner because the greater ambient air pressure creates a force that tends to prevent the liner from being removed from the receptacle. No attempts in the related art have adequately addressed the above-stated problems. Thus, a vented trash receptacle solving the aforementioned problems is desired.

### SUMMARY OF THE INVENTION

The vented trash receptacle has walls encompassing an inner space. The receptacle has a closed bottom and an open top. A removable lid is provided to close the open top when desired. Handles are disposed on the outer surface of the receptacle. Hollow vent tubes are attached to the outer surface of the receptacle. Each tube has a lower end that opens into the inner space of the receptacle adjacent the closed bottom. The upper end of each tube opens into a respective chamber formed beneath a respective handle, thereby preventing foreign objects and substances from clogging the tube passageways.

Accordingly, the invention presents a vented trash receptacle that provides vent structure to enhance insertion and removal of flexible liners. The vent structure is disposed in a manner to prevent clogging thereof. The invention provides for improved elements thereof in an arrangement for the purposes described that are inexpensive, dependable and fully effective in accomplishing their intended purposes.

These and other features of the present invention will become readily apparent upon further review of the following specification and drawings.

### BRIEF DESCRIPTION OF THE DRAWINGS

FIG. 1 is an environmental, perspective view of a first embodiment of a vented trash receptacle according to the present invention.

FIG. 2 is a section view taken along lines 2-2 of FIG. 1.

FIG. 3 is a partial side view in section, showing an upper portion of the vented trash receptacle of FIG. 1.

FIG. 4 is a partial side view in section showing a lower portion of the vented trash receptacle of FIG. 1.

FIG. 5 is an environmental, perspective view of a second embodiment of a vented trash receptacle according to the present invention.

FIG. 6 is a section view taken along lines 6-6 of FIG. 5.

FIG. 7 is a bottom perspective view of the vented trash receptacle of FIG. 5.

Similar reference characters denote corresponding features consistently throughout the attached drawings.

### DETAILED DESCRIPTION OF THE PREFERRED EMBODIMENTS

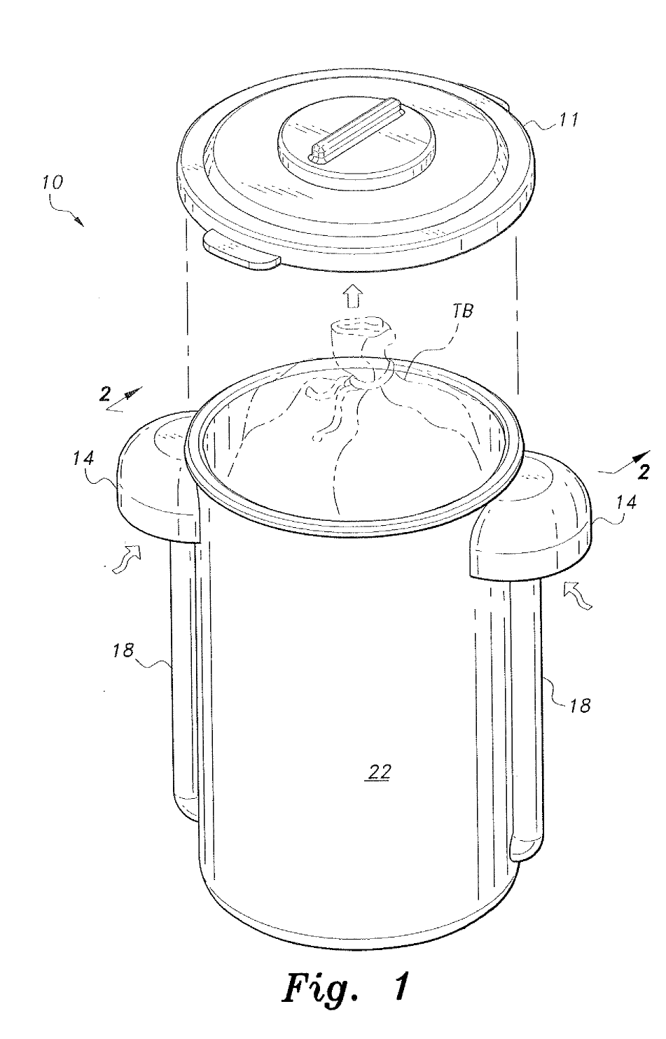

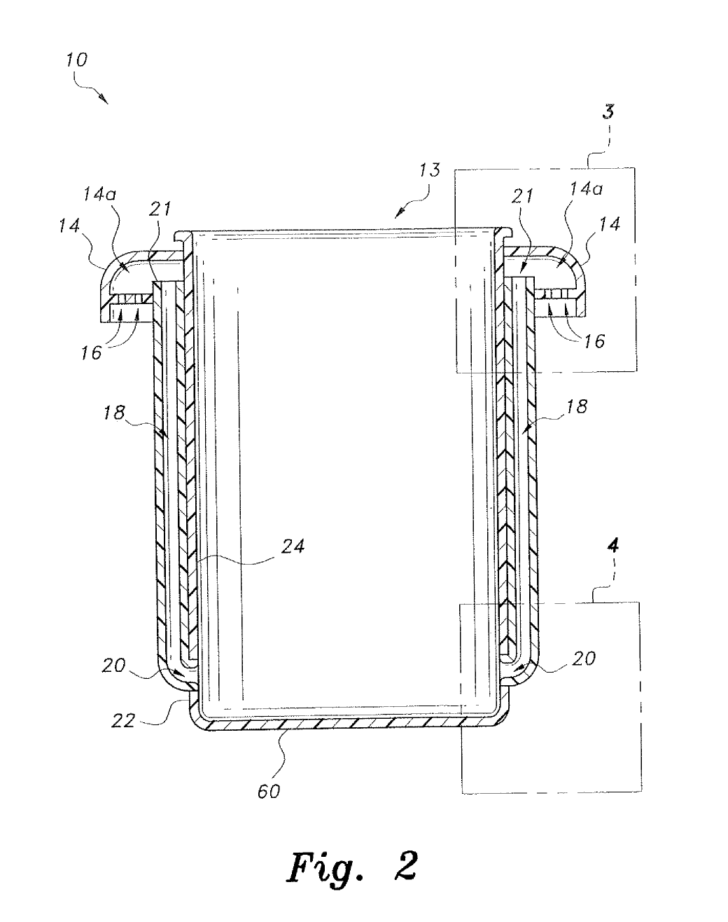

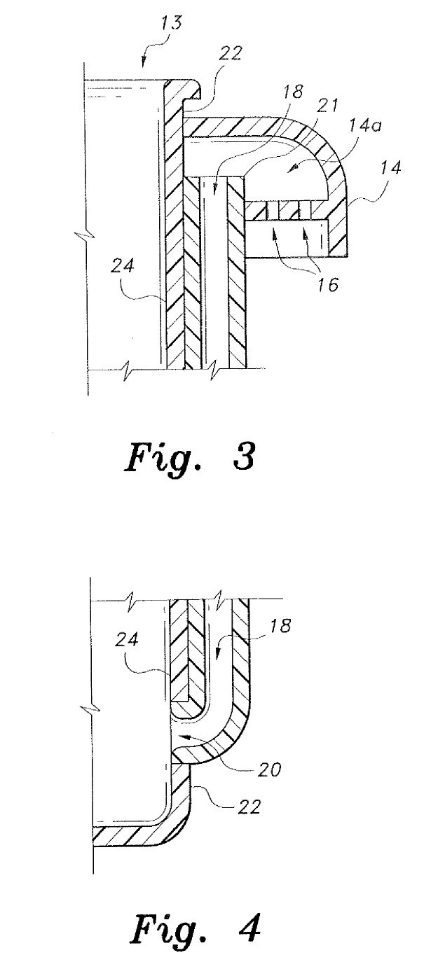

Referring to FIGS. 1-4, a first embodiment of the vented trash receptacle is generally indicated at 10. A wall having an outer surface 22 and an inner surface 24 forms a container for receiving a trash liner TB therein. Although illustrated as cylindrically configured, it should be noted that the container may be fashioned in other configurations (square, rectangular, etc.), if desired. The receptacle 10 is provided with an open top 13 and a wall 60 closing the bottom thereof. A removable lid 11 functions to close the open top 13. A pair of diametrically opposed handles 14 is provided on the outer surface 22. As shown in FIGS. 2 and 3, each handle 14 has an outer convex configuration that forms a respective concave chamber 14a beneath the undersurface of each handle 14. Respective partitions having vent openings 16 therein provide access for air to flow to and from the chambers 14a. An air freshener may be inserted into the chambers 14a, if desired. Two vent tubes 18 are disposed on the outer surface 22 and are positioned so that each tube 18 extends downward along the outer surface 22 below a respective handle 14. Each tube 18 has a respective upper end 21 that opens into a respective chamber 14a. As shown in FIG. 4, the lower end 20 of each tube 18 opens into the interior of the receptacle 10 closely adjacent the bottom wall 60. The lower ends 20 are diametrically opposed and are rounded to present a smooth surface in transitioning with the inner surface 24 to prevent the liner from being caught, snagged, or torn thereon.

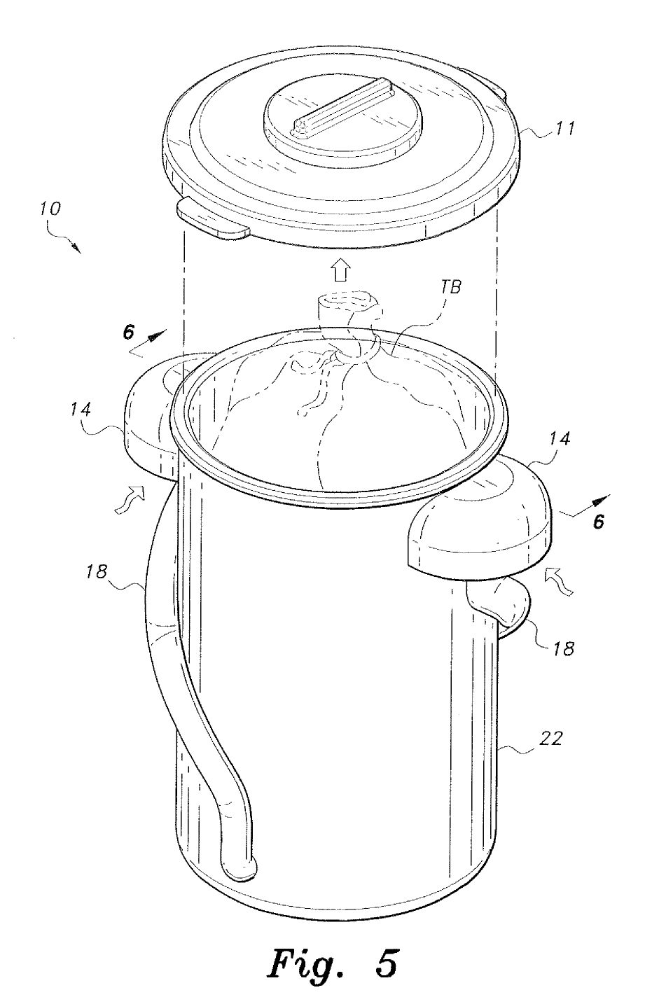

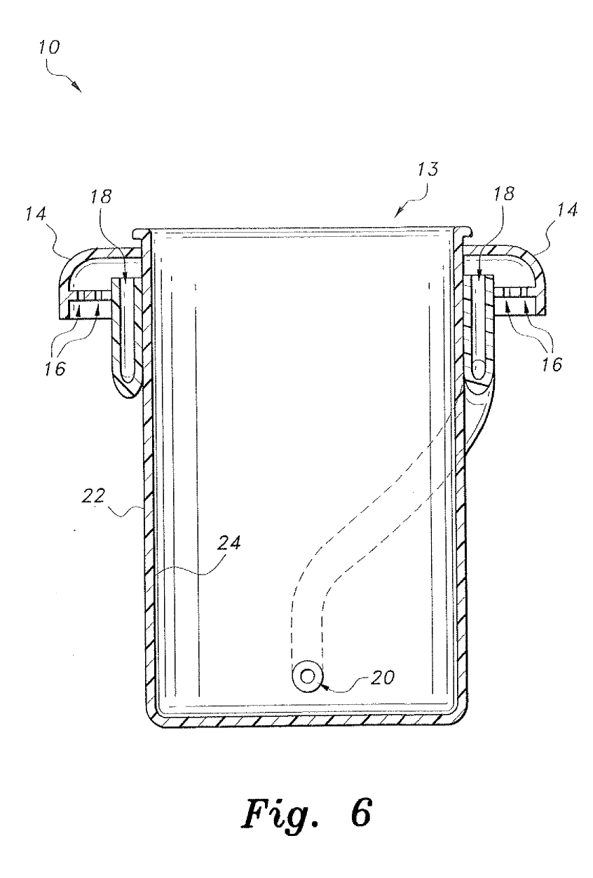

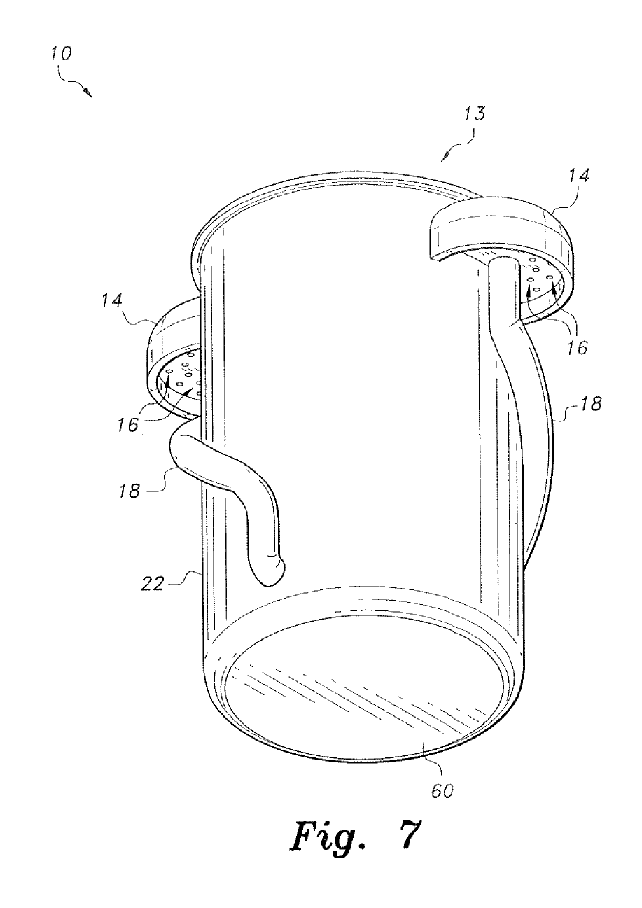

As best seen in FIGS. 5-7, in a second embodiment, the receptacle 10 provides tubes 18 are helically wrapped in opposite directions around the outer surface 22 of the receptacle 10 and the lower ends of the tubes 18 enter the receptacle 10 at areas spaced 90° from the handles 14. This arrangement provides for a rotational effect for airflow as the air enters the receptacle 10.

In use, when a liner is inserted, air that might be trapped adjacent the bottom 60 of the receptacle 10 is expelled through the vent structure. thereby allowing the liner to be easily inserted into the receptacle. When removing the trash-laden liner, ambient air flows through the vent structure to prevent a vacuum from occurring, as described above, thereby enhancing the removal of the liner.

It is to be understood that the present invention is not limited to the embodiments described above, but encompasses any and all embodiments within the scope of the following claims.

We claim:

1. A vented trash receptacle, comprising:
at least one wall forming a housing having an open top, a bottom, an outer surface and an inner surface;
a lower wall closing the bottom of the housing;
a pair of handles positioned on the outer surface of the housing, each of the handles having an undersurface;
a pair of air chambers, each of the handles having a corresponding one of the air chambers defined adjacent the undersurface of the handle, respectively, the chambers being open to receive ambient air and extending through the wall of the housing; and
a pair of vent tubes, each of the tubes having an upper end and a lower end, the upper end of each of the vent tubes opening into a corresponding one of the air chambers, respectively, and the lower end of each of the vent tubes opening into the housing at the inner surface adjacent the bottom.

2. The vented trash receptacle according to claim 1, wherein said handles are diametrically opposed on the outer surface of said housing.

3. The vented trash receptacle according to claim 1, further including a removable lid for closing the open top of said housing.

4. The vented trash receptacle according to claim 1, wherein the lower end of each of the vent tubes is rounded to present a smooth surface in transition with the inner surface of said housing.

5. The vented trash receptacle according to claim 1, wherein the lower ends of the vent tubes open into the housing at diametrically opposed positions.

6. The vented trash receptacle according to claim 1, wherein each said handle has a convex outer surface and a concave undersurface defining the respective air chamber under said handle.

7. A vented trash receptacle, comprising:
at least one wall extending 360° to form a housing having an open top, a bottom, an outer surface and an inner surface;
a wall closing the bottom of the housing;
a pair of handles positioned diametrically opposite each other on the outer surface of the housing, each of the handles having an undersurface;
a pair of air chambers, each of the handles having a corresponding one of the air chambers defined under the handle adjacent the undersurface thereof, the chambers being open to receive ambient air and extending through the wall of the housing, each of the air chambers having a partition positioned beneath the undersurface of the corresponding handle to form a lower wall of the air chamber, each of the partitions having vent holes therethrough providing for air flow to and from the corresponding air chamber; and
a pair of vent tubes, each of the tubes having an upper end and a lower end, the upper end of each of the vent tubes opening into a corresponding one of the air chambers, respectively, and the lower end of each of the vent tubes opening into the housing at the inner surface adjacent the bottom.

8. The vented trash receptacle according to claim 7, wherein each said tube is helically wrapped around the outer surface of said housing.

9. The vented trash receptacle according to claim 7, further including a removable lid for closing the open top of said housing.

10. The vented trash receptacle according to claim 7, wherein the lower end of each said vent tube is rounded to present a smooth surface in transition with the inner surface of said housing.

11. The vented trash receptacle according to claim 7, wherein the lower ends of the vent tubes open into the housing at diametrically opposed positions.

12. The vented trash receptacle according to claim 7, wherein each said handle has a convex outer surface and a concave undersurface defining the corresponding air chamber under the handle.

13. A vented trash receptacle, comprising:
at least one wall extending 360° to form a housing having an open top, a bottom, an outer surface and an inner surface;
a wall closing the bottom of the housing;
a pair of handles positioned diametrically opposite each other on the outer surface of the housing, each of the handles having a convex outer surface and a concave undersurface;
a removable lid for closing the open top of the housing;
a pair of air chambers, each of the handles having a corresponding one of the air chambers defined under the handle adjacent the undersurface thereof, the chambers being open to receive ambient air and extending through the wall of the housing, each of the air chambers having a partition positioned beneath the undersurface of the corresponding handle to form a lower wall of the air chamber, each of the partitions having vent holes therethrough providing for air flow to and from the corresponding air chamber; and
a pair of vent tubes, each of the tubes having an upper end and a lower end, the upper end of each of the vent tubes opening into a corresponding one of the air chambers, respectively, and the lower end of each of the vent tubes opening into the housing at the inner surface adjacent the bottom.

14. The vented trash receptacle according to claim 13, wherein the lower ends of the vent tubes open into said housing at diametrically opposed positions, and wherein the lower end of each of the vent tubes is rounded to present a smooth surface in transition with the inner surface of said housing.

15. The vented trash receptacle according to claim 14, wherein each said tube is helically wrapped around the outer surface of said housing.
